(19) United States
(12) Patent Application Publication
(10) Pub. No.: US 2013/0297540 A1
(43) Pub. Date: Nov. 7, 2013

(54) SYSTEMS, METHODS AND COMPUTER-READABLE MEDIA FOR GENERATING JUDICIAL PREDICTION INFORMATION

(71) Applicant: Robert Hickok, Philadelphia, PA (US)

(72) Inventor: Robert Hickok, Philadelphia, PA (US)

(21) Appl. No.: 13/799,018

(22) Filed: Mar. 13, 2013

Related U.S. Application Data
(60) Provisional application No. 61/640,933, filed on May 1, 2012.

(51) Int. Cl. G06N 3/04

(52) U.S. Cl. CPC G06N 3/0472
USPC 706/21

(57) ABSTRACT

Systems, methods and computer-readable storage media for generating judicial prediction information are described. A judicial information prediction system may be configured to receive an analysis request comprising judicial request elements and to access at least one judicial information source associated with the analysis request. The judicial request elements may include items of interest associated with the prediction of a legal action. For example, the judicial request elements may include a court, a judge, an area of the law, and a legal action, such as a motion to dismiss. The judicial information prediction system may operate to analyze the at least one judicial information source based on the judicial request elements to generate judicial prediction information. For instance, the judicial prediction information may indicate the likelihood of success of a legal event based on the circumstances specified in the analysis request.

### CROSS REFERENCE TO RELATED APPLICATION(S)

This application claims priority under 35 U.S.C. §119(e) to U.S. Provisional Application No. 61/640,933, filed on May 1, 2012, the contents of which are incorporated by reference in their entirety as if fully set forth herein.

### BACKGROUND

Each action that a party initiates during a legal proceeding is associated with various costs, such as time, legal fees and resources. For example, during litigation, a party may pursue a motion for summary judgment in an attempt to have a court decide a case before the commencement of certain judicial processes, such as discovery or court proceedings. For the moving party, one benefit is that case may be decided in their favor without the time and expense of a full trial. However, the motion for summary judgment is also associated with certain costs, such as legal fees and resource utilization costs. Accordingly, one useful factor for deciding whether to pursue such a motion, or other legal action, strategy, or the like, is the probability of the court granting the motion. If a party had information suggesting that such a motion would likely not be granted, the party may decide to avoid the associated costs and not file the motion. Alternatively, if the party had information that the motion would likely be granted, such information may persuade the party to expend the associated costs and file the motion.

Legal professionals and other interested parties currently do not have access to the type of information that would allow them to ascertain potential outcomes for legal actions in a cost-efficient manner. According to existing technology and legal practice, such research is done on a case-by-case basis and generally costs the same or substantially the same as pursuing the legal action or strategy. As such, there would be a great benefit to a system capable of providing efficient and cost-effective potential outcomes for legal actions, such as filing a motion or pursing a particular legal strategy.

### SUMMARY

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

In an embodiment, a judicial prediction information system may comprise a processor and a non-transitory, computer-readable storage medium in operable communication with the processor. The computer-readable storage medium may include one or more programming instructions that, when executed, cause the processor to receive an analysis request comprising judicial request elements, access at least one judicial information source associated with the analysis request, and analyze the at least one judicial information source based on the judicial request elements to generate judicial prediction information.

In an embodiment, a computer-implemented method for generating judicial prediction information by a processor may comprise receiving an analysis request comprising judicial request elements, accessing at least one judicial information source associated with the analysis request, and analyzing the at least one judicial information source based on the judicial request elements to generate judicial prediction information.

In an embodiment, a computer-readable storage medium may have computer-readable program code configured to generate judicial prediction information embodied therewith. The computer-readable program code may be configured to receive an analysis request comprising judicial request elements, access at least one judicial information source associated with the analysis request, and analyze the at least one judicial information source based on the judicial request elements to generate judicial prediction information.

### BRIEF DESCRIPTION OF THE DRAWINGS

The above and other objects of the present invention will become more readily apparent from the following detailed description taken in connection with the accompanying drawings.

FIG. 1 depicts an illustrative prediction system according to some embodiments.

FIG. 2 depicts at least a portion of an illustrative database entry according to some embodiments.

FIG. 3 depicts an illustrative computer system for generating prediction information according to an embodiment.

FIG. 4 depicts an illustrative analysis request according to some embodiments.

FIG. 5 depicts a user interface for configuring an analysis request according to some embodiments.

FIG. 6 depicts an illustrative prediction results user interface according to some embodiments.

FIG. 7 depicts a flow diagram for an illustrative method for analyzing judicial decision making and, based upon the analysis, predicting future judicial decisions according to some embodiments.

FIG. 8 depicts a flow diagram for an illustrative method of generating judicial prediction information using a prediction system configured according to some embodiments.

FIG. 9 illustrates various embodiments of a computing device for implementing the various methods and processes described herein.

### DETAILED DESCRIPTION

The present disclosure is directed to a system and method for providing judicial prediction information. For example, the judicial prediction information may include, without limitation, outcome predictions for legal actions, information associated with the outcome predictions, probabilities associated with the outcome predictions, degrees of certainty associated with the outcome predictions, and/or sources that form the basis of one or more outcome predictions. The legal actions may include various types of actions associated with a legal proceeding. Non-limiting examples of legal actions include filing a case, filing a motion, pursuing a legal strategy, pursuing a defense, filing a case with a particular judicial entity (for example, state court, federal court, or the like). The outcome predictions may include predictions of success and/or failure for a particular legal action represented in various forms, such as the use of terms (for example, “success” and “failure”), probabilities, or by providing support and/or reasoning for and/or against a particular legal action (for example, providing a judicial opinion associated with the legal action).

According to some embodiments, a user may access a judicial prediction information system (the “prediction system”) and enter an analysis request that includes a legal action. For instance, the analysis request may request that the prediction system provide prediction information associated with pursuing a particular legal strategy. The analysis request may be associated with certain judicial request elements that operate to specify the analysis request. Illustrative and non-restrictive examples of judicial request elements include case type, legal issues, court system, and judicial actor (for example, a particular judge). The prediction system may receive the analysis request and analyze one or more information sources based on the judicial request elements of the analysis request. The prediction system may generate prediction information based on the analysis of the information sources. For instance, the prediction system may generate prediction information including the probability of success for a particular legal action, the certainty of the probability of success, and at least a portion of the information that the prediction system used as the basis for the probability of success (for example, legal opinions, legal treatises, or the like).

According to some embodiments, the prediction system may be configured to analyze judicial decision making and, based upon the analysis, predict future judicial decisions. A database or other similar data structure may be provided, the database including a listing of all judicial decisions within a court system. The court system may include any court system capable of operating according to embodiments described herein, include the court systems of the states and territories of the United States and the Federal court system (including all of the district courts, courts of appeal, and the Supreme Court), municipal courts, county courts, foreign courts, and specialty courts (for example, bankruptcy courts). The database may include specific details for each individual case such as the type of case, the type of issue being decided and procedural posture on which any issues are decided. By using various data mining techniques, this information may be analyzed and predictions about future decisions may be made for certain circumstances, such as a particular judge in a particular case or about the decisions of sets of judges in particular jurisdictions.

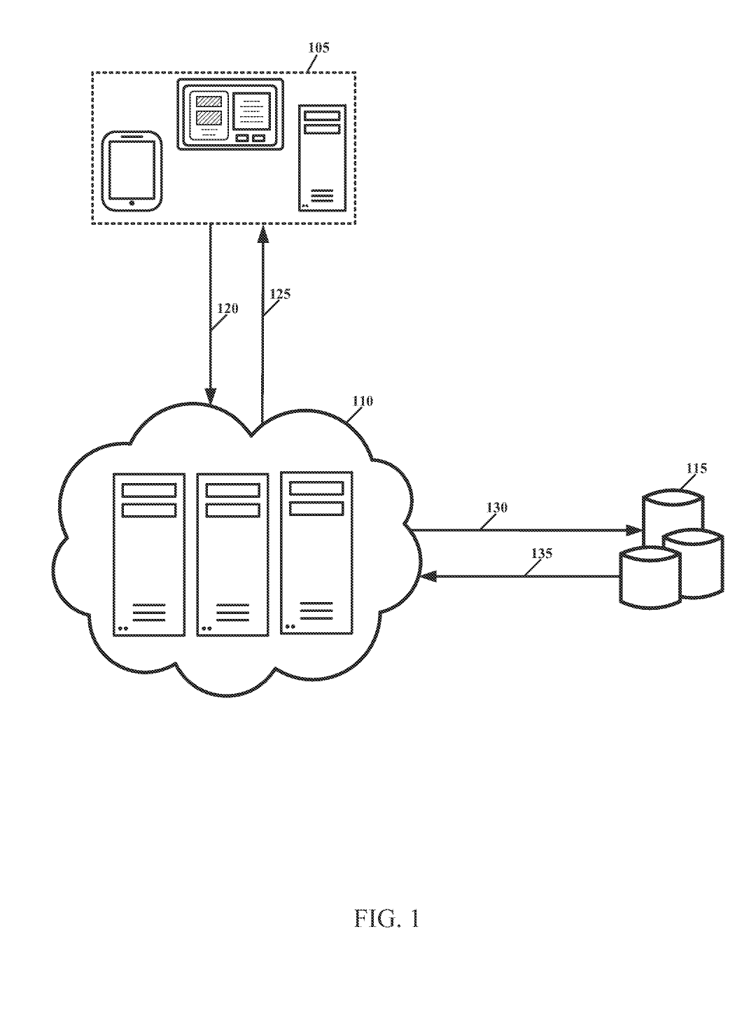

FIG. 1 depicts an illustrative prediction system according to some embodiments. As shown in FIG. 1, client devices 105 may access a prediction system 110. For example, a client device 105 may send an analysis request 120 to the prediction system 110, and the prediction system may analyze 130 information sources 115 based on the analysis request. In an embodiment, the prediction system 110 may include one or more computing devices, such as servers arranged in a network. The prediction system 110 may retrieve 135 information from the information sources 115 based on the analysis request 120. The retrieved 135 information may be used by the prediction system 110 to generate prediction information 125 for communication to the requesting client device 105.

Although the information sources 115 are depicted in FIG. 1 as being external to the prediction system, embodiments are not so limited. According to certain embodiments, some, all or substantially all of the information sources 115 may be included in the prediction system 110. In a non-limiting example, an information source 115, such as a database, may be stored on a computing device of the prediction system 110, such as on one or more data servers. In another non-limiting example, an information source 115 may include a third-party information source (such as LexisNexis®, Westlaw®, Bloomberg Law®, court system document services (for example, the Public Access to Court Electronic Records (PACER) system, or the like) remotely accessed by the prediction system 110. According to some embodiments, the prediction system 110 may use both internal and external information sources 115.

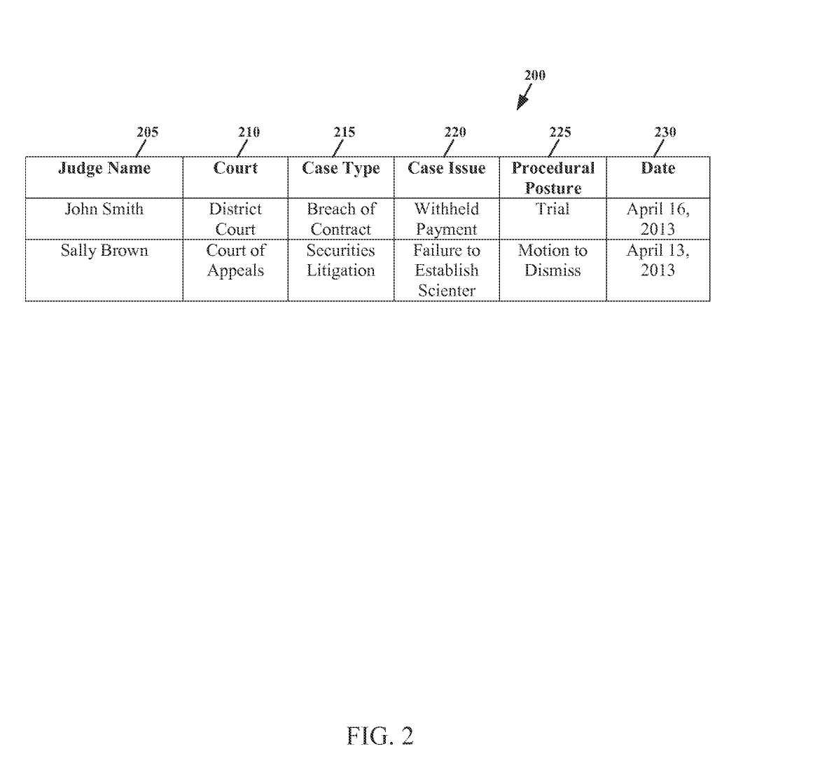

The information sources 115 may include various information resources. Illustrative and non-restrictive examples include databases, digital files, such as digital documents (for example, judicial opinions, articles, such as newspaper, magazine, and/or law review articles, books, or the like), websites, multimedia files, audio files, video files, or the like. Accordingly, embodiments are not limited to any particular form of information resource. Indeed, any form in existence or developed in the future capable of operating according to an embodiment is contemplated herein. For example, the information sources 115 may include databases storing various types of information, such as information associated with judicial decisions. Illustrative information includes the court, judges, parties, witnesses, submitted documents (for instance, complaint, answer, motions, or the like), and/or any judicial opinions released during the proceeding associated with the judicial decision. An example database entry is depicted in FIG. 2 and described below. In another example, an entity, such as a law firm, may develop a database based on their own research, experience, or the like, for inclusion in the information sources 115 available to the prediction system 110. In a further example, the information sources 115 may include documents in a digital, computer-readable form.

FIG. 2 depicts at least a portion of an illustrative database entry according to some embodiments. As shown in FIG. 2, at least a portion of a database entry 200, such as those stored in information sources 115 as shown in FIG. 1, may include various elements of information. As discussed above, a database used by the prediction system may include all judicial decisions made within a particular court system, such as the Federal court system, one or more state court systems, or the like. The database may be constructed and arranged to include multiple columns 205, 210, 215, 220, 225, 230, each column having a related heading and being sortable according to standard database organizational techniques. As shown in portion 200, columns headings may include judge name 205, court 210, case type 215, case issue 220, procedural posture 2225, and date 230. Each row of the database may be related to an individual case or legal decision. Each data point (i.e., a point in a single row and column) in the database may be fillable with unique text, or each data point may have a drop down menu that limits the choices used to fill in the column. For example, the judge name 205 column may be set such that each data point in that column may be filled with unique text, for example, the name of a judge or “en banc.” In an embodiment, the court 210 column may be set such that when a user enters information into that column, the user is presented with a drop-down list, or other similar listing, of court names, limiting the user to select from the list. In this manner, a uniform entry style for specific columns may be provided, for instance, allowing for those columns to be easily sorted and searched. However, embodiments are not limited to a drop-down list, as information may also be entered manually, for example, through keyboard entry.

The case type 215 column may be used to define the specific legal category an individual entry falls into. For example, case type 215 may include securities litigation cases, antitrust cases, breach of contract cases, patent infringement cases, product liability cases, and other similar categories of cases. Similarly, case issue 220 may be used to define a specific aspect of the case. For example, case issue 220 may include standing, failure to state claim, failure to establish scienter, failure to establish antitrust injury, failure to prove willful infringement, class certification, or the like. The procedural posture 225 column may indicate how the case issue is decided. For example, procedural posture 225 may include motion to dismiss, motion for class certification, motion for summary judgment, trial, decision on appeal, and other procedural postures.

As shown in FIG. 2, the various data contained within the database may be arranged or aggregated into various data sets. For example, all decisions made by a particular judicial actor (for example, Judge John Smith) may be organized into a single data set and sorted by case type 215, date 230 or other heading. Similarly, a data set may be organized for a particular judicial entity, such as a specific court. For example, all cases decided by the United States District Court for the Eastern District of Pennsylvania may be organized into a single data set. This data set may then be aggregated, for instance, with all of the courts in the Third Circuit of the United States. This aggregated data set may then be further aggregated with all of the other Federal district courts. Similar data sets may be made for appeals courts, state courts, the Supreme Court, or the like.

Embodiments are not limited to the configuration of information as shown in FIG. 2, as the portion 200 of the database is depicted for illustrative purposes only. For instance, more or fewer columns 205, 210, 215, 220, 225, 230 may be included providing various types of information. Additional information may include, without limitation, biographical information pertaining to judicial actors (for example, age, gender, political affiliation, educational background, employment history, or the like), links to information sources, judicial opinions, or the like.

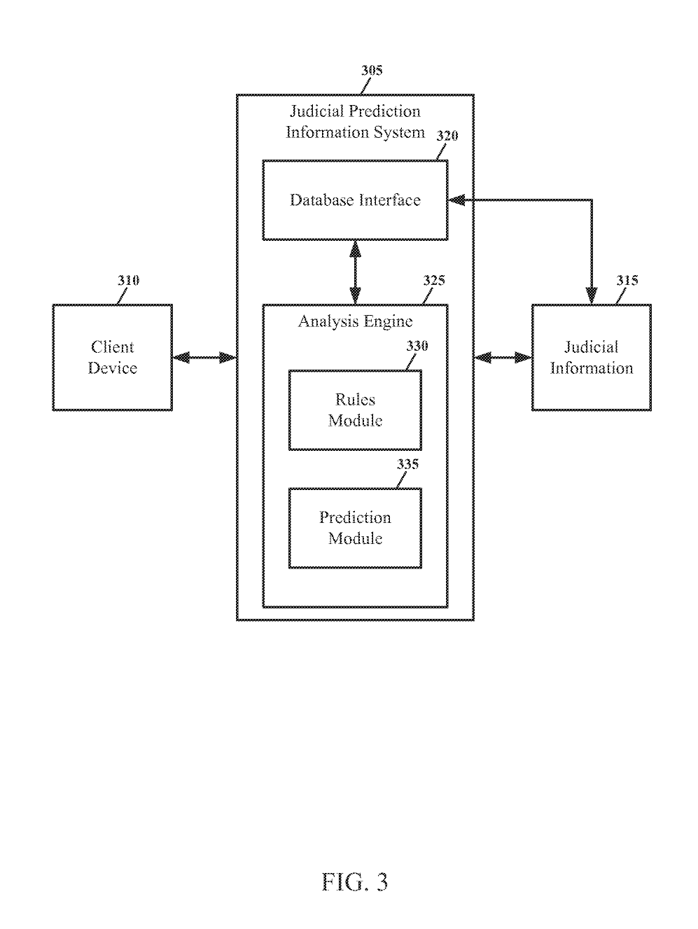

FIG. 3 depicts an illustrative computer system for generating prediction information according to an embodiment. As shown in FIG. 3, a judicial prediction information system computing device 305 may be configured to execute software operative to, among other things, analyze judicial decision making and, based upon the analysis, generate prediction information, such as by predicting future judicial decisions. A client device 310 may be in operable communication with an analysis engine 325 configured to access and interpret information contained within a judicial information source 315. In an embodiment, the client device 310, the analysis engine 325 and the judicial information source 315 may be integrated into a single computing device. In another embodiment, the client device 310, the analysis engine 325 and the judicial information source 315 may be integrated into more than one computing device. For instance, the client device 310 may include a client computing device (for example, a mobile computing device, a laptop computing device, a smartphone, a tablet computing device, a personal computer (PC), a server, or the like) configured to remotely access the prediction system computing device 305, which may include one or more server computing devices.

The client device 310 may be operably connected to the analysis engine 325 via a wired or wireless data connection, such as an Ethernet connection, a local area network connection (e.g., a company intranet), a wide area network connection (e.g., the Internet), or any other type of data connection known to those having ordinary skill in the art. The analysis engine 325 also may be operably connected to the judicial information source 315 via a wired or wireless data connection. In this manner, a user may have remote access to the software being executed at the prediction system computing device 305, which may operate to promote scalability as multiple client devices may be operably connected to the analysis engine 325 simultaneously. Additionally, multiple analysis engines 325 may be operably connected to the judicial information source 315.

The analysis engine 325 may be configured to receive a request from the client device 310 and produce a set of results based upon analysis of relevant information contained in the judicial information source 315. For example, a user may create a query at the client device 310 requesting the predicted results of a breach of contract case, heard in the United States District Court for the Eastern District of Pennsylvania by Judge Smith. The analysis engine 325 may parse the request and search the judicial information source 315 for relevant data via a database interface 320 and extract the relevant data. The database interface 320 may provide an interface between one or more internal databases (not shown) resident on the prediction system computing device 305 and/or the judicial information source 315 using database interfaces known to those having ordinary skill in the art.

The analysis engine 325 may analyze the extracted data and produce one or more result sets based upon the analyzed data via a prediction module 335. The prediction module 335 may be configured to determine relationships between the information stored in the one or more internal databases and/or the judicial information sources 315 and to generate one or more predictions for the current user query based upon those relationships.

In an embodiment, the prediction module 335 may be configured to perform the analysis and report generation according to data mining and statistical analysis techniques that are maintained by a rules module 330. For example, the rules module 330 may be configured to perform one or more heuristic algorithms for processing the analyzed data. Alternatively, the rules module 330 may include various statistical analysis tools such as Bayesian inference techniques, regression analysis techniques, analysis of variance techniques, Monte Carlo simulation models, Bernoulli trials, or the like. Based upon instructions from the rules module 330, the prediction module 335 may produce prediction information associated with the query.

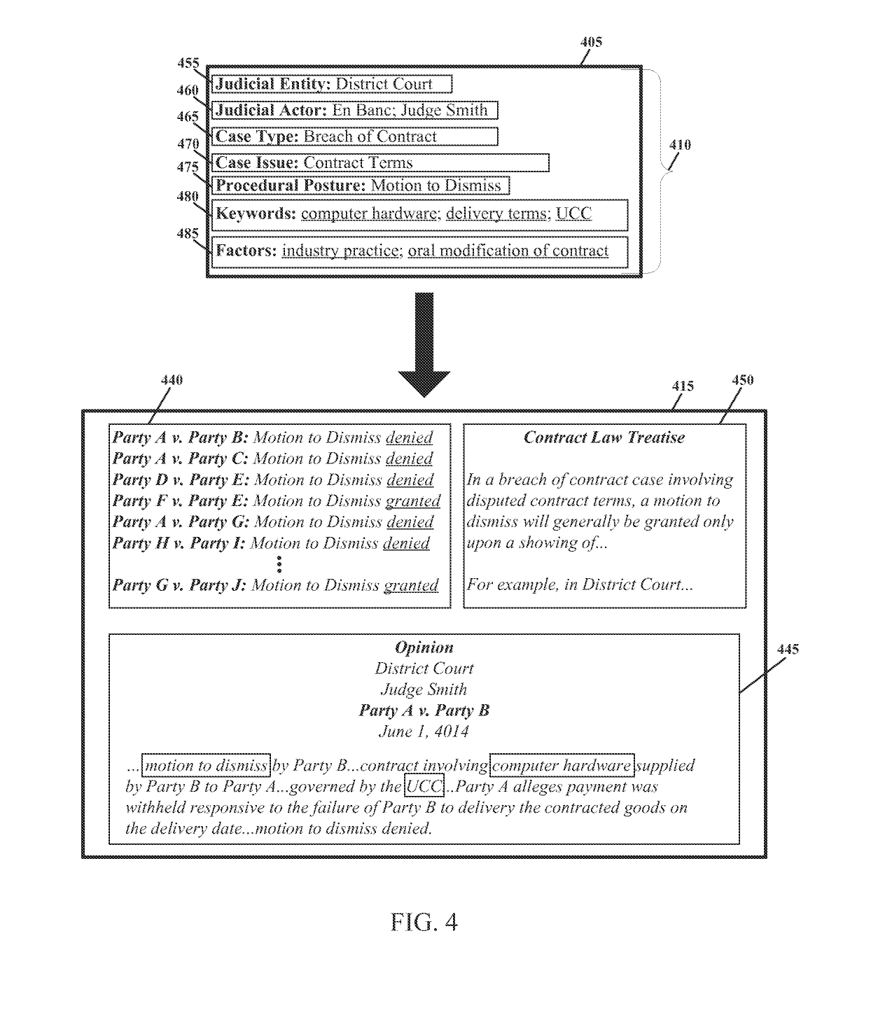

FIG. 4 depicts an illustrative analysis request according to some embodiments. As shown in FIG. 4, an analysis request 405 may include various request elements 410. The request elements 410 may be configured to specify information of interest for the analysis request 405, including, without limitation, a judicial entity 455, a judicial actor 460, a case type 465, a case issue 470, a procedural posture 475, keywords 480, and factors 485. The judicial entity 455 may include the judicial decision making body, such as a court, arbitration panel, administrative decision making body (e.g., United States Patent and Trademark Office (USPTO) Patent Trial and Appeal Board (PTAB)), or the like. The judicial actor 460 may include a decision making member of the judicial entity 455, such as a particular judge, decision maker, and/or judicial entity configuration (for example, en banc).

The case type 465 may be configured to indicate the area of law that is the focus of the analysis requests 405, such as contract law, patent law, bankruptcy, securities litigation, employment law, and any other definable area of law. The case issue 470 may include one or more specific legal issues, such as a particular legal action, area of the law, legal element, or the like. For instance, the case issue 470 may include, without limitation, particular motions, elements that must be proven for a successful case (for example, breach of duty for a personal injury case, offer acceptance for a breach of contract case, or the like), legal strategies, areas of the law, such as areas of the law within a particular case type 465 (for example, contract formation for a breach of contract case, consumer confusion for a trademark infringement case, or the like). The procedural posture 475 may include the status of the case (for example, at trial, discovery, or the like) and/or a particular legal procedure, such as the filing of a motion to dismiss.

Keywords 480 may include various terms that may operate to focus the analysis request 405. For example, a user may only want to focus on breach of contract cases that fall under the Uniform Commercial Code (UCC), that deal with delivery terms, and/or that involve computer hardware goods. In an embodiment, the keywords 480 may be used in a manner substantially similar to search terms in a keyword search engine known to those having ordinary skill in the art. Factors 485 may include legal or circumstantial factors that may be relevant to the analysis request 405. For example, a user may want to obtain prediction information for cases in which the decision making body considered certain legal issues, such as industry practices and/or oral modification of a contract in a breach of contract case, or particular cases that are pertinent to the case and/or court system. Through the keywords 480 and/or factors 485, a user may concentrate their analysis request 405 for their particular case to receive more customized and accurate prediction information.

Although FIG. 4 depicts a particular set of request elements 410, embodiments are not so limited, as any type of request element capable of operating according to embodiments is contemplated herein. Additional, non-limiting examples of request elements 410 include elements configured to specify information sources 415, search result configurations (for example, reporting functions), degrees of certainty, prediction information configuration (for example, success/failure, probability percentages, or the like), exclusion elements (for example, exclude opinions involving Judge Smith), or the like.

The prediction system may receive the analysis request 405 and analyze information sources 415 based on the request elements 410. For instance, the prediction system may analyze judicial results 440, judicial opinions 445, and/or non-judicial opinion information sources 450. In an embodiment, the judicial results 440 may be obtained from various sources, including third-party information sources (for example, LexisNexis®, Westlaw®, PACER, or the like), internal databases (for example, compiled by a user entity, such as a law firm or corporate legal department), or from searching legal opinions. The judicial results 440 may include the results of rulings, such as rulings on motions, or other judicial outcomes, including bench verdicts, jury verdicts, or the like. In this manner, the prediction system may analyze judicial results 440 in view of the request elements 410. For example, analysis of the judicial results 440 may demonstrate that a particular court grants motions for summary judgment at a rate less than 33%, that a large corporate plaintiff is more likely to be found negligent in a particular court or court system than an individual plaintiff or small corporate plaintiff, or other conclusions that may be generated through the information in the information sources 415.

In an embodiment, the information sources 415 may include judicial opinions 445 that may be analyzed by the prediction system based on the request elements 410. For example, the judicial opinions 415 may be analyzed to locate particular opinions that are relevant to the analysis request 405. The prediction system may operate to analyze the judicial opinions 415 to generate prediction information, for example, by determining the relevancy of an opinion to the analysis request 405 and the judicial outcome written in the opinion.

In an embodiment, the information sources 415 may include non-judicial opinion information sources 450, such as legal treatises, law review articles, non-opinion writings of a judicial actor, books, or the like. For instance, non-judicial opinion information sources 450 may be analyzed to determine the judicial posture of a particular judicial actor on a certain issue (for example, a particular judicial actor may have given speeches regarding the enforcement of certain environmental laws relevant to the analysis request 405), to determine the legal precedents that may affect the decisions of a particular court (for example, as included in a legal treatise), the likelihood that a court may or may not follow precedent, or the like.

The prediction system may obtain search results as a result of analyzing the information sources 415 based on the request elements 410 of the analysis request 405. The search results may be analyzed based on various processes to generate prediction information. For example, the prediction system may use the number of judicial opinions for a particular judicial actor that provide a particular judicial result, such as granting a motion for summary judgment, to generate prediction information. The prediction information may include a probability of success for a legal action, such as a motion for summary judgment, specified in the analysis request 405. For example, if relatively more judicial results are in favor of a legal action, a higher probability that the legal action will be successful may be inferred or identified. In another example, if relatively more of the circumstances (for instance, the facts of the case) associated with the previous judicial results are related to the request elements 410 of an analysis request 405, a higher probability that the legal action will have a similar outcome may be inferred or identified. In a further example, the more authorities (for instance, legal treatises, higher courts, or the like) and/or opinions that are in favor of a particular legal action under particular circumstances, the more likely that the legal action may be successful, and vice versa.

In an embodiment, the request elements 410 and/or information sources 415 may be weighted to provide differential effects on the prediction information. Some embodiments provide that the prediction system may include a user-configurable weighting scheme with certain default weighting parameters. For instance, judicial opinions by the judicial entity 455 and/or the judicial actor 460 may be given more weight than non-judicial opinion information 445 or judicial opinions by other judicial actors. In another instance, a user may specify the weight, order, and/or importance of a request element 410, such as giving more weight to the procedural posture 475 than the case issue 470. Embodiments are not limited to the aforementioned weighting techniques. Indeed, as any weighting technique capable of operating according to some embodiments is contemplated herein.

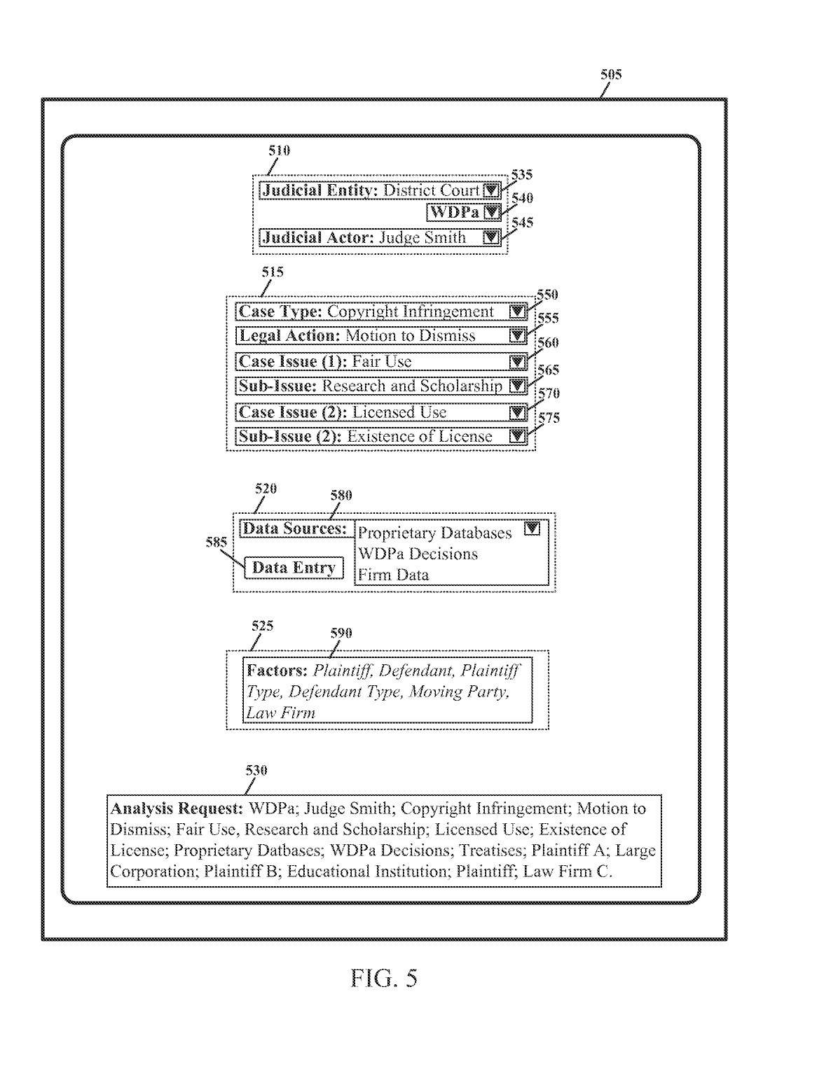

FIG. 5 depicts a user interface for configuring an analysis request according to some embodiments. As shown in FIG. 5, a user interface 505 may include various data entry categories 510, 515, 520, 525 for a user to build an analysis request. According to some embodiments, the user interface 505 may be accessible from a client computing device through various platforms, such as a client application, web-based application, over the Internet, and/or a mobile application (for example, a “mobile app” or “app”).

The user interface 505 may include a judicial information 510 data entry category configured to allow a user to specify judicial information for an analysis request. Illustrative judicial information may include a judicial entity 535, a judicial actor 545, or the like. The elements may include drop-down menus with pre-filled information, including information based on selections of other elements. For instance, when a user sets the judicial entity 535 element to “District Court,” a court entity 540 element may be pre-filled with the courts that make up the particular court system or may include a selection for “all courts,” or the like, to select all or substantially all of the courts in a selected system. According to some embodiments, each selection element (for example, 535, 540 and other such elements described herein) may be similarly set to an “all” or “any” setting that will provide for the selection of all or substantially all items within the particular scope of the selection element (for instance, all court systems, all databases, all judges, all judge configurations, or the like).

A case information 515 data entry category may include elements configured to allow a user to specify certain aspects of a case and/or legal action that is the focus of the analysis request. For instance, case type 550 and legal action 555 may be provided to specify a particular area of the law and/or legal action, respectively. Elements may also be included for specifying particular legal issues 560, 570 and sub-issues 565, 575 related thereto. In an embodiment, elements may also be provided to specify other details associated with a case and/or legal action (not shown), such as the outcome of the case and/or legal action. For example, the user may only want to use decisions that were decided in a particular manner, such as motions to dismiss that were granted.

A data sources 520 data entry category may include elements for selecting information sources that may be used for the analysis request, including the selection of all or substantially all available information sources. According to some embodiments, the prediction system may be configured to use certain information sources by default or by default based on the selection of other elements. For instance, if the judicial entity 535 is set to a Federal district court, the prediction system may exclude state court opinions. Through a data sources 580 element, a user may review and/or select the information sources that may be analyzed by the prediction system.

In an embodiment, a data entry 585 function may be provided on the user interface 505, for example, within the data sources 520 data entry category. The data entry 585 function may allow users to enter information into a database, such as a database maintained by a law firm or other entity. In this manner, an entity may include their research, information, or the like according to their database configuration for use by the prediction system. Such databases may be available for selection through the data sources 580 element.

A factors 525 data entry category may allow a user to specify certain factors 585 that the prediction system may use when analyzing the selected information sources. Illustrative factors include the parties, the types of parties (e.g., corporations, municipalities, individuals, or the like), law firms, or the like. As the user builds the analysis request, an analysis request 530 element may display the items (for example, as a search string) currently selected for the analysis request.

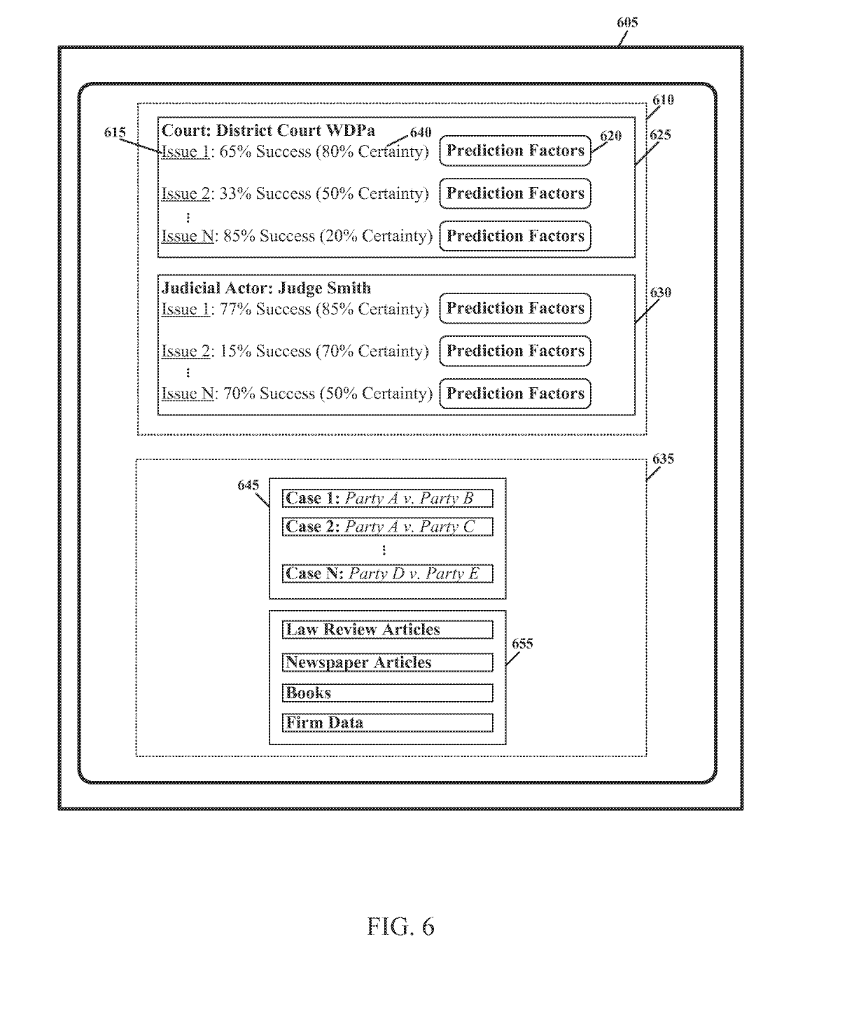

FIG. 6 depicts an illustrative prediction results user interface according to some embodiments. As shown in FIG. 6, a user interface 605 may be configured to display prediction results 610 generated by the prediction system responsive to analyzing judicial information based on an analysis request. The prediction results 610 may include results for various entities, such as a court 625 and/or a judicial actor 630. In this manner, a user may compare prediction results at various levels of granularity. For instance, a court may have a certain probability associated with a particular judicial outcome; however, the probability for a particular judge that presides in the court may have a much different probability.

The prediction results 610 may be configured according to various methods. For example, the prediction results 610 may include the issues and/or sub-issues 615 specified in an analysis request along with prediction information 640. As depicted in FIG. 6, the prediction information 640 may include a probability (for example, a probability of success) along with a degree of certainty configured to indicate a confidence level of the prediction information. The degree of certainty may be determined based on various items of information, including, without limitation, the number of supporting information sources (for example, judicial opinions), the authority of the information sources, the decision maker (for example, a higher confidence level may be associated with the same judicial actor as opposed to another judicial actor within the specified court), and combinations thereof.

A prediction factors 620 element may be included to allow users to access information used by the prediction system when generating the prediction information. For example, selection of a prediction factors 620 element may open a prediction factors window 635 configured to provide access to various sources of information used to generate the prediction information, such as judicial decision information 645 (for example, court opinions, court decisions, or the like) and non-judicial decision information 655 (for example, treatises, articles, databases, or the like). In an embodiment, relevant sections of the prediction factors 645, 655 used in generating the prediction results 610 may be highlighted.

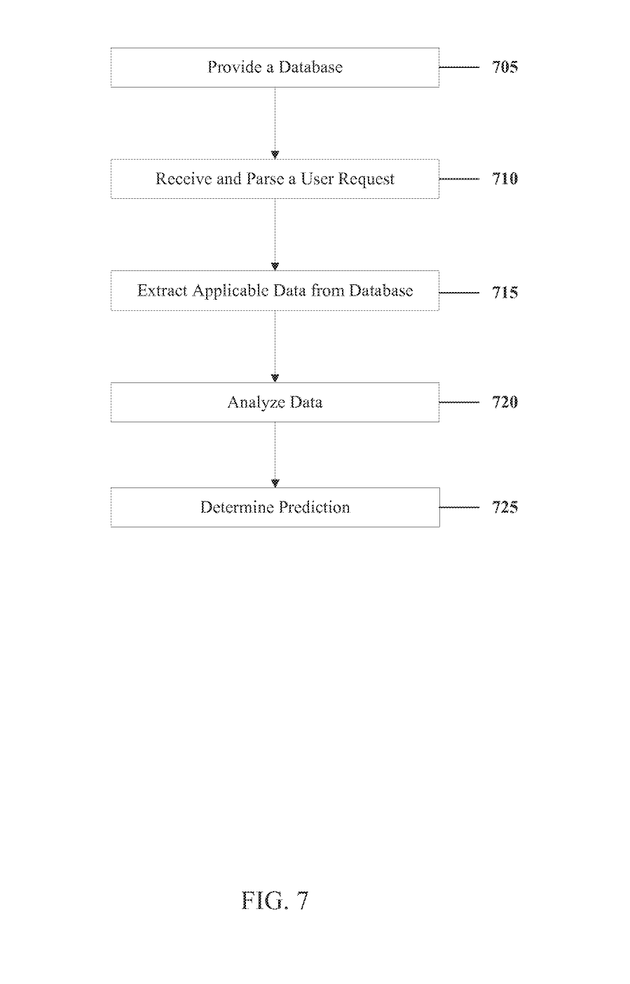

FIG. 7 depicts a flow diagram for an illustrative method for analyzing judicial decision making and, based upon the analysis, predicting future judicial decisions according to some embodiments. A database, similar to those as described above and configured to store data sets related to historical judicial decisions, may be provided 705. Similar to the system as shown in FIG. 3, the database may be accessible via an analysis module (for example, analysis engine 325). The analysis module may receive and parse 710 a user request for information. For example, the user may request the probability of Judge Sally Brown issuing a motion to dismiss in a securities litigation where there has been a failure to establish scienter. The analysis module may parse 710 the request for important information, and extract 715 related information from the database. In this example, the analysis device may extract 715 all decisions made by Judge Sally Brown in cases involving securities litigation.

The analysis device may analyze 720 the extracted 715 data. The analyzing 720 may include using standard statistical analysis techniques such as Bayesian inference, regression analysis, analysis of variance, Monte Carlo simulation models, Bernoulli trials, and/or other similar techniques. For example, using Bayesian inference, a likelihood function for a specific event occurring may be determined based upon analysis of at least two previously occurring events and a prior probability of those previously occurring events. To continue the above example, all data for Judge Sally Brown relating to securities litigation where there has been a failure to establish scienter may be analyzed 720 and two or more occasions where she issued a motion to dismiss may be identified. The overall probability of this result occurring for these two events is calculated and, based upon the overall probability, a likelihood result may be determined. Based upon the likelihood result, the analysis device may determine 725 one or more predictions for the user's request. In the above example, the analysis device may determine 725 that there is a high likelihood that Judge Sally Brown will grant a motion to dismiss in securities litigation where there has been a failure to establish scienter, as determined from an analysis 720 of her previous decisions.

The process as described above in FIG. 7 may be used to make informed predictions about decisions a judge may make in a particular case, or about the decisions of sets of judges in particular jurisdictions. For example, in an antitrust case filed in the District Court for the Eastern District of Pennsylvania and assigned to Judge John Smith, the informed prediction may involve a likelihood that he will grant a motion to dismiss based upon a failure to establish antitrust injury. In another example, if plaintiff's counsel has a choice of jurisdictions within which to file a class action complaint, the informed prediction may involve which jurisdiction has the highest probability of certifying the class action. In a further example, if a defendant has a choice of litigating a particular defense at the motion to dismiss stage, the summary judgment stage, or the trial stage, the informed prediction may involve determining at which stage does the defendant have the lowest and highest probability of prevailing on the defense. Embodiments are not limited to these prediction decisions, as these are provided for illustrative purposes only.

Additionally, the process as described above in FIG. 7 may be used to analyze correlations among the decisions of judges included within the database to make a determination 725. For example, if the decisions of Judge John Smith are strongly correlated with the decisions of Judge Sally Brown and Judge Tim Jones, then the decisions of Judge Sally Brown and Judge Tim Jones may be used as proxy variables for the decisions of Judge John Smith. According to some embodiments, such use of proxy variables may help address various issues with a judicial entity and/or judicial actor, such as small sample sizes, when predicting the decision of a particular judge within the database.

For example, a plaintiff may want to predict the likelihood of Judge John Smith granting a motion to dismiss a securities litigation for failure to establish scienter. The database may not include similar examples for Judge John Smith from which to predict the decision. However, the database may include examples of Judge Sally Brown granting a motion to dismiss a securities litigation for failure to establish scienter. An analysis of all decisions made by Judge John Smith and Judge Sally Brown may result in a 75% decision correlation between the judges. Based upon this decision correlation, the prediction system may generate prediction information, such as predicting that there is a high likelihood that Judge John Brown will decide in the same manner as Judge Sally Brown on this legal action.

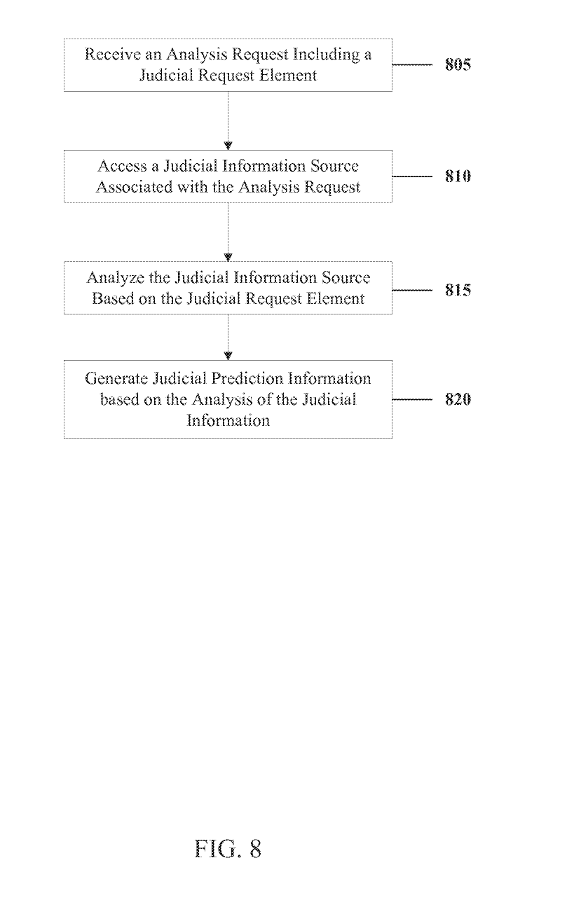

FIG. 8 depicts a flow diagram for an illustrative method of generating judicial prediction information using a prediction system configured according to some embodiments. An analysis request may be received 805 by the prediction system. For example, a user may configure an analysis request to include a judicial request element at a client computing device and may transmit the analysis request to the prediction system. The judicial request element may include various elements that may be used to formulate prediction information, including, without limitation, judicial entities, judicial actors, areas of the law, legal issues, or the like.

The prediction system may access 810 a judicial information source associated with the analysis request. The prediction system may be in operable communication with various judicial information sources, such as databases including judicial information, such as judicial entity information, judicial actor information, decision information, or the like. Responsive to receiving 805 an analysis request, the prediction system may determine which judicial information sources will be analyzed. In an embodiment, the prediction system may analyze all available judicial information sources. In another embodiment, the prediction system may determine which judicial information sources are relevant to the analysis request. For example, only state court judicial information sources may be relevant for an analysis request including a judicial request element indicating that the user is interested in the decisions of a particular state judicial system.

The prediction system may analyze 815 the judicial information source based on the judicial request element. For example, the prediction system may search for judicial information, such as judicial decisions, associated with a particular area of law, legal action, and result specified in the judicial request elements of an analysis request. Analyzing 815 the judicial information may include various processes, such as keyword searching and/or statistical analysis. Judicial prediction information may be generated 820 by the prediction system based on the analysis 815 of the judicial information. For example, the prediction system may use the results of the analysis 815 to generate probabilities for legal actions specified in the judicial request elements of an analysis request.

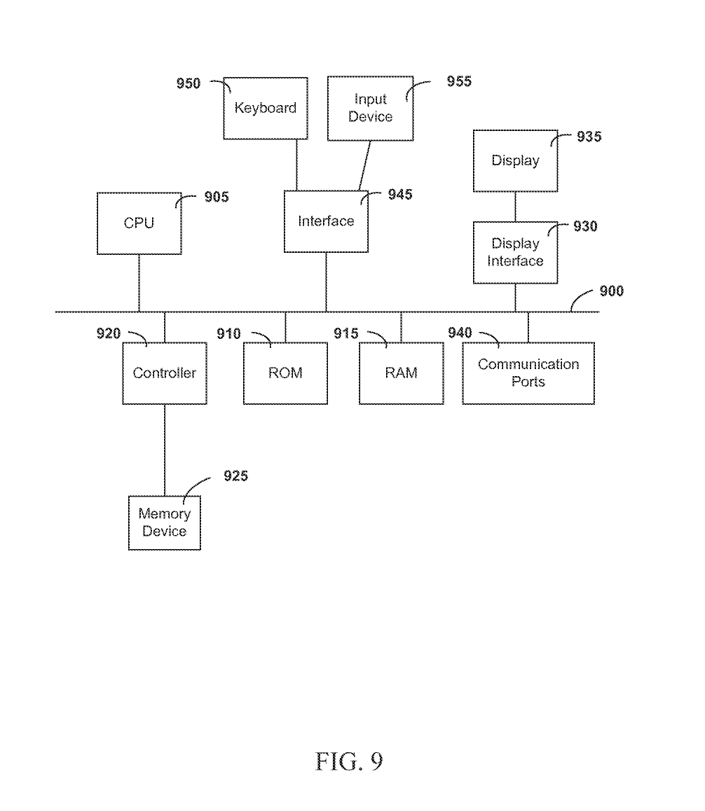

FIG. 9 depicts a block diagram of exemplary internal hardware that may be used to contain or implement the various computer processes and systems as discussed above. A bus 900 serves as the main information highway interconnecting the other illustrated components of the hardware. CPU 905 is the central processing unit of the system, performing calculations and logic operations required to execute a program. CPU 905, alone or in conjunction with one or more of the other elements disclosed in FIG. 9, is an exemplary processing device, computing device or processor as such terms are used within this disclosure. Read only memory (ROM) 930 and random access memory (RAM) 935 constitute exemplary memory devices.

A controller 920 interfaces with one or more optional memory devices 925 to the system bus 900. These memory devices 925 may include, for example, an external or internal DVD drive, a CD ROM drive, a hard drive, flash memory, a USB drive or the like. As indicated previously, these various drives and controllers are optional devices. Additionally, the memory devices 925 may be configured to include individual files for storing any software modules or instructions, auxiliary data, common files for storing groups of results or auxiliary, or one or more databases for storing the result information, auxiliary data, and related information as discussed above. For example, the memory devices 925 may be configured to store judicial information source 315.

Program instructions, software or interactive modules for performing any of the functional steps associated with the analysis of judicial decision making as described above may be stored in the ROM 930 and/or the RAM 935. Optionally, the program instructions may be stored on a tangible computer-readable medium such as a compact disk, a digital disk, flash memory, a memory card, a USB drive, an optical disc storage medium, such as a Blu-ray™ disc, and/or other recording medium.

An optional display interface 930 may permit information from the bus 900 to be displayed on the display 935 in audio, visual, graphic or alphanumeric format. The information may include information related to a current job ticket and associated tasks. Communication with external devices may occur using various communication ports 940. An exemplary communication port 940 may be attached to a communications network, such as the Internet or a local area network.

The hardware may also include an interface 945 which allows for receipt of data from input devices such as a keyboard 950 or other input device 955 such as a mouse, a joystick, a touch screen, a remote control, a pointing device, a video input device and/or an audio input device.

It will be appreciated that various of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which alternatives, variations and improvements are also intended to be encompassed by the following claims.

What is claimed is:

1. A judicial prediction information system comprising:
a processor; and
a non-transitory, computer-readable storage medium in operable communication with the processor, wherein the computer-readable storage medium contains one or more programming instructions that, when executed, cause the processor to:
receive an analysis request comprising judicial request elements;
access at least one judicial information source associated with the analysis request; and
analyze the at least one judicial information source based on the judicial request elements to generate judicial prediction information.

2. The system of claim 1, wherein the judicial request elements comprise at least one of the following: a judicial entity, a judicial actor, a case type, a case issue, a procedural posture, at least one keyword, and at least one factor.

3. The system of claim 1, wherein the judicial request elements comprise at least one judicial entity, at least one judicial actor and at least one case issue.

4. The system of claim 3, wherein the at least one judicial entity comprises at least one of the following: a court, a court system, an arbitration panel, and an administrative decision making body.

5. The system of claim 3, wherein the at least one judicial actor comprises at least one of the following: a judge, an arbitration judge and an administrative decision maker.

6. The system of claim 3, wherein the at least one judicial information source comprises at least one of the following: a judicial information database, judicial opinions, and non-judicial opinion information sources.

7. The system of claim 1, wherein the judicial prediction information comprises a probability of success.

8. The system of claim 7, wherein the judicial prediction information comprises a degree of certainty for the probability of success.

9. The system of claim 7, wherein the judicial prediction information comprises factors used to determine the probability of success.

10. The system of claim 1, wherein the at least one judicial information source is analyzed using at least one of the following statistical analysis tools: Bayesian inference, regression analysis, variance analysis, Monte Carlo simulation models, and Bernoulli trials.

11. A computer-implemented method for generating judicial prediction information, the method comprising, by a processor:
receiving an analysis request comprising judicial request elements;
accessing at least one judicial information source associated with the analysis request; and
analyzing the at least one judicial information source based on the judicial request elements to generate judicial prediction information.

12. The computer-implemented method of claim 11, wherein generating the judicial prediction information comprises generating a probability of success.

13. The computer-implemented method of claim 12, wherein generating the judicial prediction information comprises generating a degree of certainty for the probability of success.

14. The computer-implemented method of claim 11, wherein the at least one judicial information source is analyzed using at least one of the following statistical analysis tools:
Bayesian inference, regression analysis, variance analysis, Monte Carlo simulation models, and Bernoulli trials.

15. The computer-implemented method of claim 11, further comprising determining correlations between at least one of the judicial request elements and corresponding judicial elements stored in the at least one judicial information source.

16. The computer-implemented method of claim 11, further comprising, by a processor:
receiving user information through user input; and
updating the at least one judicial information source with the user information.

17. A computer-readable storage medium having computer-readable program code configured to generate judicial prediction information embodied therewith, the computer-readable program code comprising:
computer-readable program code configured to receive an analysis request comprising judicial request elements;
computer-readable program code configured to access at least one judicial information source associated with the analysis request; and
computer-readable program code configured to analyze the at least one judicial information source based on the judicial request elements to generate judicial prediction information.

18. The computer-readable storage medium of claim 17, further comprising computer readable program code configured to generate judicial prediction information comprising a probability of success.

19. The computer-readable storage medium of claim 17, further comprising computer readable program code configured to determine correlations between at least one of the judicial request elements and corresponding judicial elements stored in the at least one judicial information source.

20. The computer-readable storage medium of claim 17, further comprising computer readable program code configured to receive user information and update the at least one judicial information source with the user information.
